(19) United States
(12) Patent Application Publication
(10) Pub. No.: US 2013/0343810 A1
(43) Pub. Date: Dec. 26, 2013

(54) DOUBLE-ENDED SELF-CLINCHING GUIDE PIN

(71) Applicant: Peninsula Components, Inc. dba Pencom, San Carlos, CA (US)

(72) Inventor: Gregg Vincent Summers, Scottsdale, AZ (US)

(73) Assignee: Peninsula Components, Inc. dba Pencom

(21) Appl. No.: 13/663,286

(22) Filed: Oct. 29, 2012

Related U.S. Application Data
(60) Provisional application No. 61/662,718, filed on Jun. 21, 2012.

(51) Int. Cl. F16B 5/00

(52) U.S. Cl. CPC F16B 5/00
USPC 403/292

(57) ABSTRACT

A double-ended self-clinching guide pin. A cylindrical body has a flange and adjacent groove formed in the middle between a first pin end and a second pin end. The flange and groove clinch to a host panel, and the two ends are used to locate and align stacked or mating panels.

### BACKGROUND

This disclosure relates generally to the field of mechanical fasteners, and more specifically, to a self-clinching, double-ended guide pin.

Guide pins precisely locate and align stacked or mating panels and chasses commonly used with electronics equipment by merging with a punched or drilled hole of an adjacent panel. They install in metallic panels and mate with metallic or fiberglass panels such as printed circuit boards. However, it would be desirable to have a guide pin that is useful for mating multiple panels.

### BRIEF DESCRIPTION OF THE DRAWINGS

FIG. 1A is a side plan view of a double-ended guide pin.

FIG. 1B is an end plan view of the double-ended guide pin of FIG. 1A.

FIG. 2A is a side plan view of the double-ended guide pin of FIG. 1A ready for installation in a metal sheet by a punch and anvil.

FIG. 2B is a side plan view of the double-ended guide pin of FIG. 2A as installed in the metal sheet.

FIG. 3 is a side plan view of an alternative embodiment of a double-ended guide pin.

FIG. 4A is a perspective view of the double-ended guide pin of FIG. 3 installed in a metal sheet in operational proximity to an ejector handle in the closed position.

FIG. 4B is a perspective view of the double-ended guide pin of FIG. 3 installed in a metal sheet in operational proximity to an ejector handle in the open position.

### DETAILED DESCRIPTION

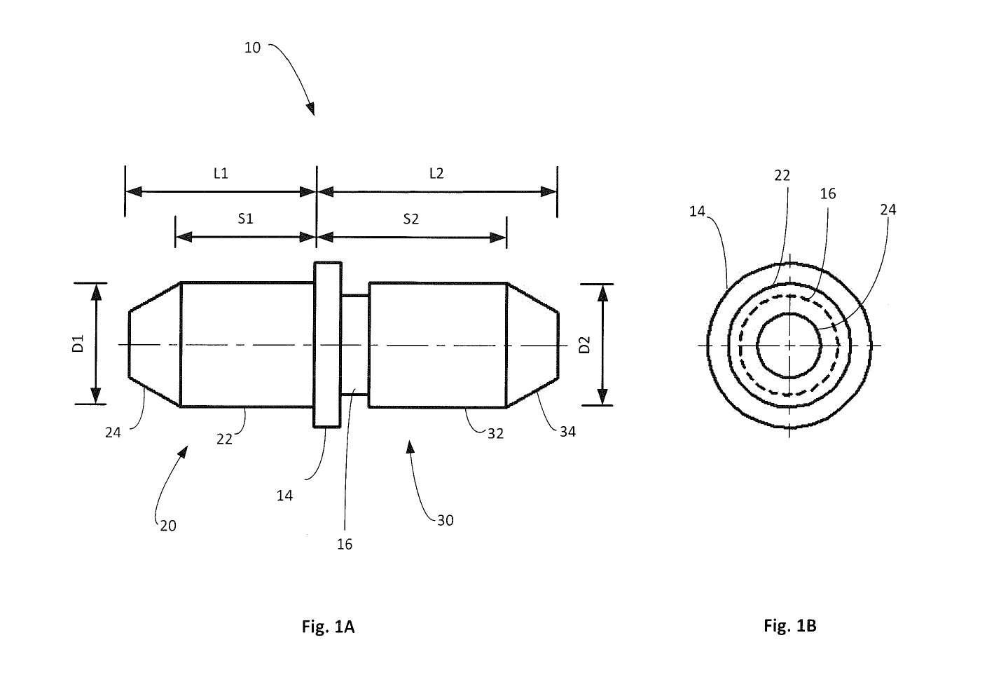

Referring now to FIGS. 1A and 1B, a first embodiment of a double-ended guide pin 10 is illustrated. In general, the guide pin 10 consists of two pin portions 20, 30 coupled together which may have similar or dissimilar diameters and lengths. A thin flange 14, larger than either diameter, and a circular groove 16, smaller than either diameter, are located between the two pin portions 20, 30. Both of the pin portions 20, 30 are generally cylindrical. The guide pin 10 clinches to the host panel and is intended to locate and align other metal panels by merging with punched or drilled holes in the panels. Other shapes could be used as well. As such, the guide pin 10 is preferably formed by turning a single piece of carbon steel or stainless steel bar on a lathe and forming a single integrated cylindrical body having the described features. A two-piece device could also be formed, for example, by press fitting the two pieces together.

The first pin portion 20 of the guide pin 10 has a body portion 22 and a head portion 24, and likewise the second pin portion 30 of the guide pin has a body portion 32 and a head portion 34. The total length of the first pin portion 20 is L1, the length of the first body portion 22 is S1, and the diameter of the first body portion 22 is D1. Likewise, the total length of the second pin portion 30 is L2, the length of the second body portion 24 is S2, and the diameter of the second body portion 22 is D2. In typical applications, guide pin diameters D1 and D2 range from 3 mm to 6 mm, and guide pin lengths L1 and L2 range from 6 mm to 25 mm.

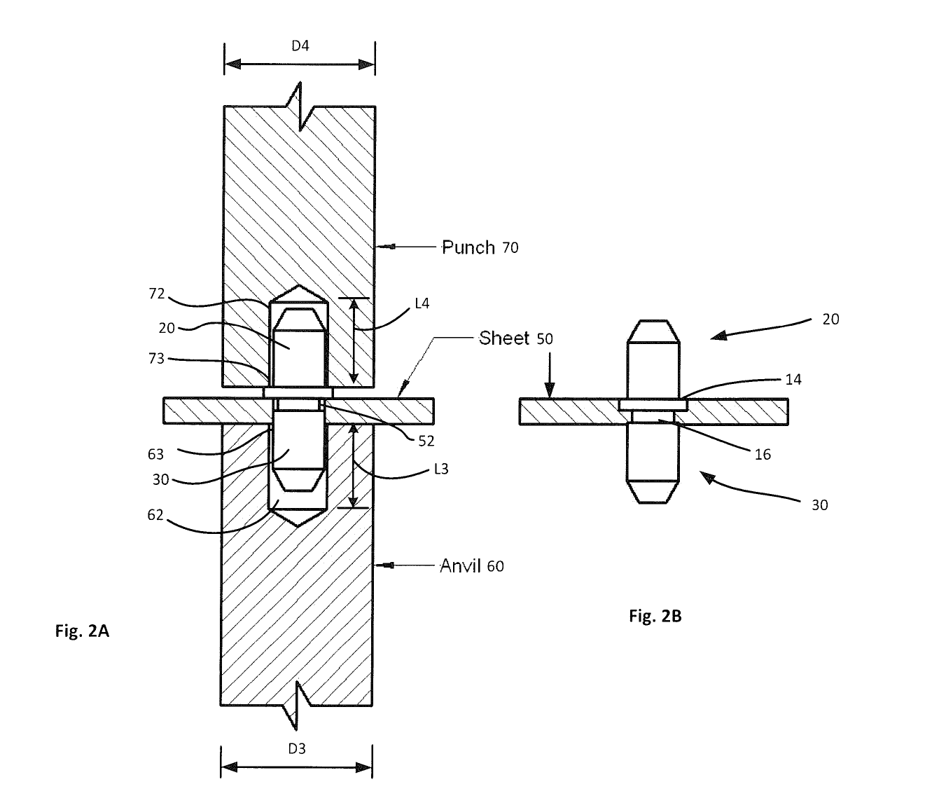

Referring now to FIG. 2A, the guide pin 10 is installed into a first metal sheet 50 by inserting the second pin portion 30 through a hole 52 in the metal sheet and into a circular anvil 60. The hole 52 in sheet 50 is a few thousandths of an inch larger than the diameter D2 of the second pin body 32. In this example, the anvil 60 has an outside diameter D3 of approximately 0.500 inches, and a recess 62 having a concentric hole 63 a few thousandths of an inch larger than the diameter D2 of body portion 32 and a depth L3 greater than the length L2 of pin portion 30.

A circular punch 70 is then positioned over the exposed pin portion 20. The punch 70 has an outside diameter D4 of approximately 0.500 inches, and a recess 72 with a concentric hole 73 a few thousandths of an inch larger than the diameter D1 of the pin portion 20, and a depth L4 slightly greater than the length L1 of the pin portion 20. The sheet 50 and guide pin flange 14 are squeezed between the punch 70 and anvil 60, for example, using a stationary hydraulic press (not shown) to displace the sheet metal around hole 52 until the guide pin flange 14 is flush with the surface of the sheet metal 50, as shown in FIG. 2B. The displaced sheet metal resulting from the embedded flange 14 flows into the circular groove 16 and permanently joins the guide pin 10 to the host sheet metal 50.

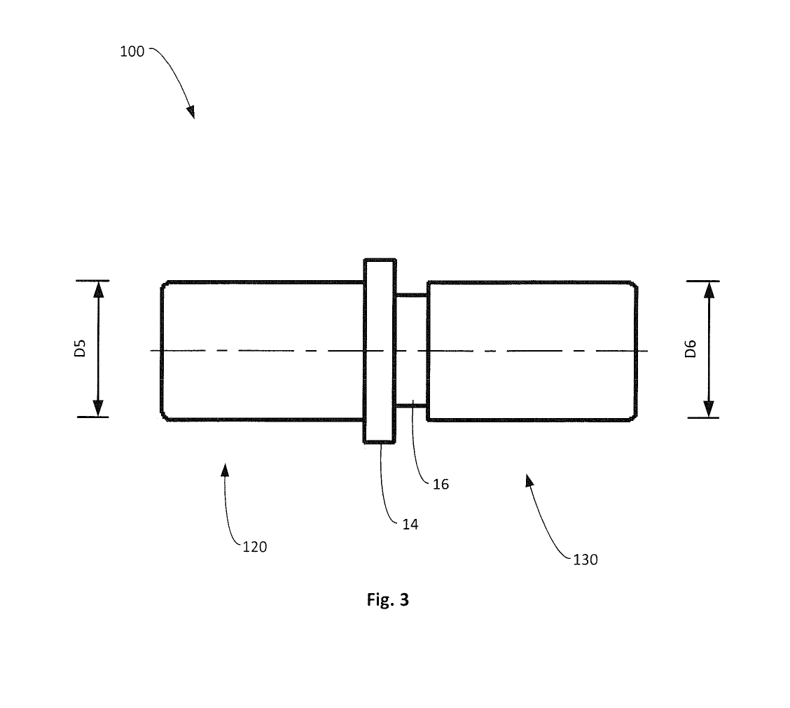

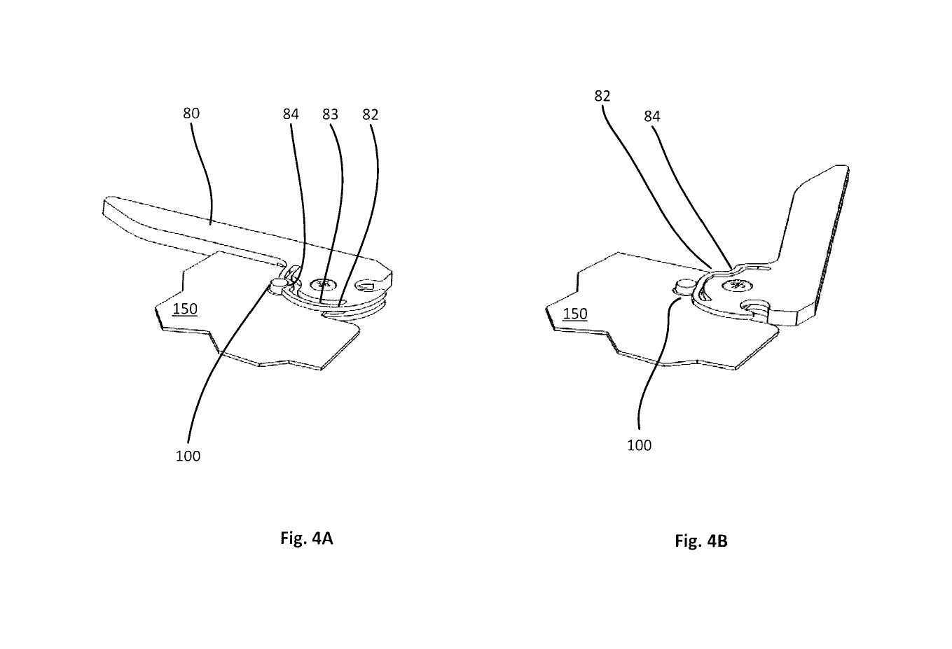

An alternate embodiment of guide pin 100 is illustrated in FIG. 3. In this embodiment, the end of each pin portion 120, 130 is straight, not tapered as in FIG. 1A, and the guide pin 100 is used as a stud or post. For example, FIGS. 4A and 4B show an ejector handle 80 affixed for rotation on panel 150.

In prior configurations for ejector handles, a coiled or slotted pin may inserted into a thin metallic panel and function as detent and/or pivot point for a rotating handle. However, such pins tend to loosen easily and are unstable because there is an insufficient connection between the pin and sheet metal. The self-clinching design of the guide pin described herein provides a stable improvement for this application.

The ejector handle 80 has a cam follower 82 formed on the handle that interacts with a guide pin 100, and a cam follower space 83 tracing the same pattern as the cam follower 82, thus allowing resilient camming action by the handle. The guide pin 100 is affixed with the panel 150 in the manner described above, such that flange 14 and groove 16 of guide pin 100 clinch the panel.

The cam follower 82 of handle 80 has a recessed portion 84 that engages the guide pin 100 when the handle is in the closed position, as in FIG. 4A. When the handle 80 is opened, the cam follower 82 is resiliently urged into the cam follower space 83 and the recessed portion 84 is pulled away from the guide pin 100, as in FIG. 4B.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A double-ended guide pin, comprising:
a body having a first end and a second end, wherein both the first end and the second end have a first size;
a flange formed between the first end and the second end of the body and having a second size larger than the first size; and
a groove formed between the first end and the second end of the body adjacent to the flange and having a third size smaller than the first size.

2. The double-ended guide pin of claim 1, wherein the first end of the body is the first size, the second end of the body is a fourth size different than the first size, the second size of the flange is larger than both the first size and the fourth size, and the third size of the groove is smaller than both the first size and the fourth size.

3. The double-ended guide pin of claim 1, wherein the body is generally cylindrical and the first size is a first diameter; wherein the flange is generally cylindrical and the second size is a second diameter; and wherein the groove is generally cylindrical and the third size is a third diameter.

4. The double-ended guide pin of claim 2, wherein the first end of the body is generally cylindrical and the first size is a first diameter; wherein the second end of the body is generally cylindrical and the fourth size is a fourth diameter; wherein the flange is generally cylindrical and the second size is a second diameter; and wherein the groove is generally cylindrical and the third size is a third diameter.

5. A double-ended guide pin, comprising:
a first pin portion having a first diameter and a first length;
a second pin portion having a second diameter and a second length and coupled to the first pin portion;
a flange having a third diameter larger than either the first or second diameters, the flange coupled between the first pin portion and the second pin portion; and
a groove having a fourth diameter smaller than either the first or second diameters, the groove coupled between the first pin portion and the second pin portion adjacent to the flange.

6. The double-ended guide pin of claim 5, wherein the first and second diameters are substantially similar.

7. The double-ended guide pin of claim 5, wherein the first and second diameters are substantially dissimilar.

8. The double-ended guide pin of claim 5, wherein one or both of the first pin portion and the second pin portion includes a tapered head.
